(19) United States
(12) Patent Application Publication
(10) Pub. No.: US 2017/0187585 A1
(43) Pub. Date: Jun. 29, 2017

(54) Technologies for validating operations of devices

(71) Applicants: Tze-Hui Yew, Bayan Lepas (MY); Peng Peng Leim, Bayan Lepas (MY); Jiin Ming Khoo, Teluk Air Tawar (MY)

(72) Inventors: Tze-Hui Yew, Bayan Lepas (MY); Peng Peng Leim, Bayan Lepas (MY); Jiin Ming Khoo, Teluk Air Tawar (MY)

(21) Appl. No.: 14/757,832

(22) Filed: Dec. 26, 2015

(51) Int. Cl. H04L 12/26

(52) U.S. Cl. CPC H04L 43/04

(57) ABSTRACT

Technologies for validating operations of devices include a host computing device. The host computing device validates the functionality of a system that includes a gateway device that is communicatively coupled to at least one sensor device. The host computing device transmits validation instructions to the gateway device to perform at least one function with respect to the at least one sensor device that is communicatively coupled to the gateway device. The host computing device also receives test data from the gateway device after transmitting the validation instructions, analyzes the test data to determine whether the system passed at least one of a functional test and a regression test, profiles the test data at least by characterizing at least one sensor data packet included in the test data, and generates a report that indicates a status of the system, based on the analysis and the profile. Other embodiments are described.

### BACKGROUND

As the Internet of Things (IoT) increasing in usage, many systems are increasing including large numbers of field devices, such as sensors, actuators, and the like. In typical IoT systems, a gateway device communicates with the pool of field devices. However, determining that the gateway device is successfully communicating with the field devices can be a relatively time-consuming manual validation process. The manual validation process typically involves performing a series of determinations for each sensor or actuator device. For example, a person must manually determine whether each field device is online and transmitting data to and/or receiving data from the gateway device. Further, the person must manually determine whether each field device is transmitting data and/or receiving data within a desired range of speeds. Additionally, the person may measure a level of packet loss to determine whether the field device is receiving and transmitting data with the gateway device in accordance with a desired level of reliability.

As the number of field devices coupled to the gateway device increases, the time required to perform the manual validation process increases correspondingly. Accordingly, when hundreds of field devices are coupled to a gateway device, the manual validation process of all of the field devices may be impracticable.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for auto-validation of field devices including a host computing device, a gateway device, and various field devices;

FIG. 2 is a simplified block diagram of at least one embodiment of an environment of the host computing device of FIG. 1;

FIGS. 3-5 are a simplified flow diagram of at least one embodiment of a method for validating functionality of the gateway device and the field devices that may be executed by the host computing device of FIGS. 1 and 2;

FIG. 6 is simplified flow diagram of another embodiment of a method for validating functionality of the gateway device and the field devices that may be performed by the host computing device of FIGS. 1 and 2;

FIG. 7 is a simplified block diagram of components of test data that may be analyzed by the host computing device of FIGS. 1 and 2;

FIG. 8 is a simplified block diagram of components of a regression test database that may be accessed by the host computing device of FIGS. 1 and 2; and

FIG. 9 is a simplified block diagram of components of a profile database that may be accessed by the host computing device of FIGS. 1 and 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

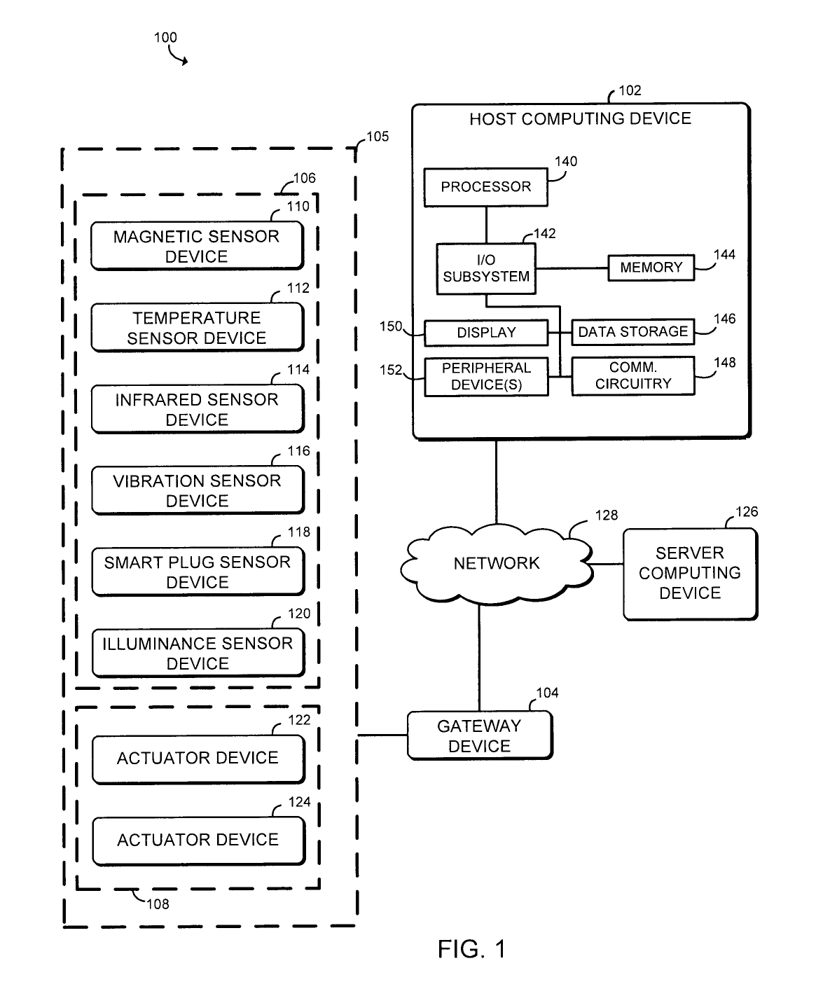

Referring now to FIG. 1, in an illustrative embodiment, a system 100 for auto-validation of field devices 105 includes a host computing device 102 coupled to a gateway device 104 via a network 128. In use, the host computing device 102 is configured to validate the functionality of the gateway device 104 and the field devices 105 coupled to the gateway device 104, thereby reducing the amount of manual testing that would otherwise be required to validate the functionality of the gateway device 104 and the field devices 105. To do so, in the illustrative embodiment, the host computing device 102 initially performs a functional test to determine whether the gateway device 104 is able to communicate at all with each field device 105. Subsequently, the host computing device 102 performs a regression test in which the host computing device 102 determines how well the gateway device 104 and the field devices 105 interoperate over an extended period of time, such as a week. In the regression test, the host computing quantifies information such as data transmission reliability (i.e., packet loss information) between the gateway device 104 and the field devices 105, as well as processor and memory utilization of the gateway device 104 during the period of time. The host computing device 102 identifies anomalies in the tests (e.g., failures to communicate with specific field devices 105 and/or relatively low data transmission reliability with specific field devices 105) and generates a report of the results of the tests for analysis by technicians. The process can be used in initial deployment, reconfiguration, and other operational modes

The host computing device 102 may be embodied as any type of device capable of validating functionality of the gateway device 104 and/or the field devices 105 and otherwise performing the functions described herein. For example, the host computing device 102 may be embodied as, without limitation, a server computer, a computer, a computing device, a workstation, distributed computing system, a multiprocessor system, a consumer electronic device, a smart appliance, a laptop computer, a notebook computer, a tablet computer, a smartphone, a mobile computing device, and/or any other computing device capable of performing the functions described herein. In some embodiment, the host computing device 102 may be embodied as a single compute device. However, in other embodiments, the host computing device 102 may be embodied as multiple devices cooperating together to facilitate the functionality described below.

As shown in FIG. 1, the illustrative host computing device 102 includes a processor 140, an I/O subsystem 142, a memory 144, a data storage device 146, a display 150, and peripheral devices 152. Of course, the host computing device 102 may include other or additional components, such as those commonly found in a workstation (e.g., various input/output devices), in other embodiments. Additionally, in some embodiments, one or more of the illustrative components may be incorporated in, or otherwise form a portion of, another component. For example, the memory 144, or portions thereof, may be incorporated in the processor 140 in some embodiments.

The processor 140 may be embodied as any type of processor capable of performing the functions described herein. For example, the processor may be embodied as a single or multi-core processor(s), digital signal processor, microcontroller, or other processor or processing/controlling circuit. Similarly, the memory 144 may be embodied as any type of volatile or non-volatile memory or data storage capable of performing the functions described herein. In operation, the memory 144 may store various data and software used during operation of the host computing device 102 such as operating systems, applications, programs, libraries, and drivers. The memory 144 is communicatively coupled to the processor 140 via the I/O subsystem 142, which may be embodied as circuitry and/or components to facilitate input/output operations with the processor 140, the memory 144, and other components of the host computing device 102. For example, the I/O subsystem 142 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 142 may form a portion of a system-on-a-chip (SoC) and be incorporated, along with the processor 140, the memory 144, and other components of the host computing device 102, on a single integrated circuit chip.

The data storage device 146 may be embodied as any type of device or devices configured for short-term or long-term storage of data such as, for example, memory devices and circuits, memory cards, hard disk drives, solid-state drives, or other data storage devices. The data storage device 146 may store, for example, validation instructions, test results, profiles, and reports.

The host computing device 102 may also include a communication circuitry 148, which may be embodied as any communication circuit, device, or collection thereof, capable of enabling communications between the host computing device 102 and other remote devices over a computer network (not shown). The communication circuitry 148 may be configured to use any one or more communication technology (e.g., wired or wireless communications) and associated protocols (e.g., MQTT, Modbus, ZigBee, Ethernet, Bluetooth®, Wi-Fi®, WiMAX, etc.) to effect such communication.

Additionally, the host computing device 102 may include a display 150. The display 150 may be embodied as any type of display capable of displaying digital information such as a liquid crystal display (LCD), a light emitting diode (LED), a plasma display, a cathode ray tube (CRT), or other type of display device. In some embodiments, the host computing device 102 may also include one or more peripheral devices 152. The peripheral devices 152 may include any number of additional input/output devices, interface devices, and/or other peripheral devices. It should be appreciated that, in some embodiments, the host computing device 102 may be embodied as multiple devices cooperating together to facilitate the functionality described below.

The field devices 105 may be embodied as any type of input or output device such as sensors, actuators, motors, and/or the like. The illustrative field devices 105 include one or more sensor devices 106 and/or one or more actuator devices 108. The sensor devices 106 may be embodied as, or otherwise include, any type of sensors. Illustratively, the sensor devices 106 include a magnetic sensor device 110, a temperature sensor device 112, an infrared sensor device 114, a vibration sensor device 116, a smart plug sensor device 118, and an illuminance sensor device 120. Of source, the sensor devices 106 may include additional or other sensor devices in other embodiments. The illustrative magnetic sensor device 110 is configured to transmit data to gateway device 104 pertaining to magnetic fields detected by the magnetic sensor device 110. The illustrative temperature sensor device 112 is configured to transmit data to the gateway device 104 pertaining to temperatures detected by the temperature sensor device 112. The illustrative infrared sensor device 114 is configured to transmit data to the gateway device 104 indicating infrared radiation detected by the infrared sensor device 114. The illustrative vibration sensor device 116 is configured to transmit data to the gateway device 104 pertaining to vibrations detected by the vibration sensor device 116. The illustrative smart plug sensor device 118 is configured to transmit data to the gateway device 104 representing energy usage of devices coupled to the smart plug sensor device 118. The illustrative illuminance sensor device 120 is configured to transmit data to the gateway device 104 indicating, for example, intensities and durations of light detected by the illuminance sensor device 120.

The actuator devices 108 may be embodied as, or otherwise include, any type of actuator device. Illustratively, the actuator device 122 include an electromechanical transducer that selectively opens and closes a switch in response to receiving corresponding commands from the gateway device 104. The actuator device 124 may be similarly configured. In some embodiments, one or more of sensor devices 106 and actuator devices 108 are incorporated into the same device, for example a smart plug.

The gateway device 104 may be embodied as any type compute device capable of performing the functions described herein, including, without limitation, a computer, a computing device, a server computer, a workstation, distributed computing system, a multiprocessor system, a consumer electronic device, a smart appliance, a laptop computer, a notebook computer, a tablet computer, a smartphone, a mobile computing device, and/or any other computing device capable of performing the functions described herein. As such, the gateway device 104 may include components commonly found in a compute device such as a processor, an I/O subsystem, a memory, a data storage device, communication circuitry, and one or more peripheral devices. Such components may be substantially similar to those like components of the host computing device 102 described above. As such, further descriptions of the like components are not repeated herein with the understanding that the description of the corresponding components provided above in regard to the host computing device 102 applies equally to the corresponding components of the gateway device 104.

The server computing device 126 may be embodied as any type compute device capable of performing the functions described herein, including, without limitation, a server computer, a computer, a computing device, a workstation, distributed computing system, a multiprocessor system, a consumer electronic device, a smart appliance, a laptop computer, a notebook computer, a tablet computer, a smartphone, a mobile computing device, and/or any other computing device capable of performing the functions described herein. As such, the server computing device 126 may include components commonly found in a compute device such as a processor, an I/O subsystem, a memory, a data storage device, communication circuitry, and one or more peripheral devices. Such components may be substantially similar to those like components of the host computing device 102 described above. As such, further descriptions of the like components are not repeated herein with the understanding that the description of the corresponding components provided above in regard to host computing device 102 applies equally to the corresponding components of the server computing device 126.

The host computing device 102 is configured to communicate with the field devices 105, the gateway device 104 104, and the server computing device 126 over a network 128 (the “cloud”). The network 128 may be embodied as any number of various wired and/or wireless networks. For example, the network 128 may be embodied as, or otherwise include, a wired or wireless local area network (LAN), a wired or wireless wide area network (WAN), a cellular network, and/or a publicly-accessible, global network such as the Internet. As such, the network 128 may include any number of additional devices, such as additional computers, routers, and switches, to facilitate communications among the devices of the system 100.

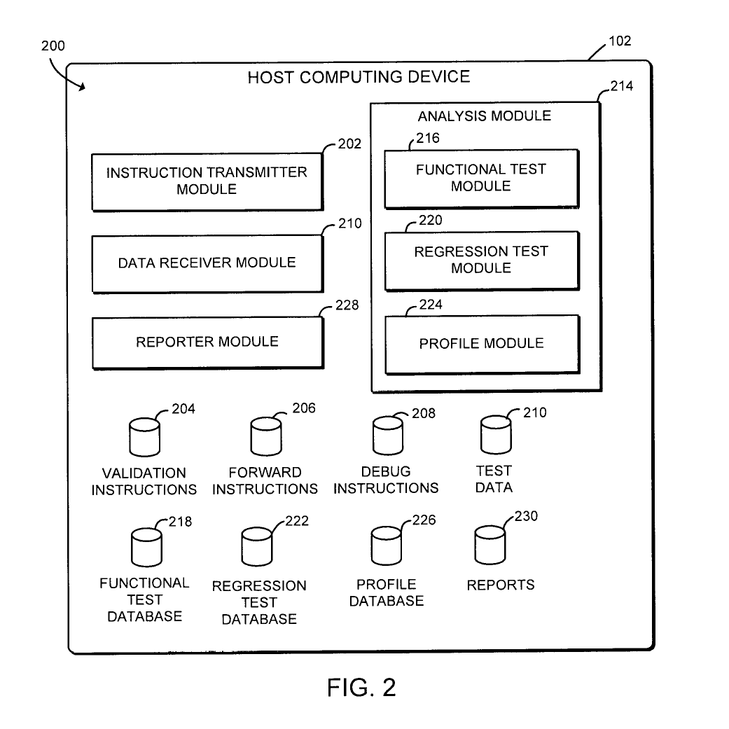

Referring now to FIG. 2, in an illustrative embodiment, the host computing device 102 establishes an environment 200 during operation. The illustrative embodiment 200 includes an instruction transmitter module 202, a data receiver module 210, an analysis module 214, and a reporter module 228. The various modules of the environment 200 may be embodied as hardware, firmware, software, or a combination thereof. As such, in some embodiments, one or more of the modules of the environment 200 may be embodied as circuitry or collection of electrical devices (e.g., an instruction transmitter circuit 202, a data receiver circuit 210, an analysis circuit 214, a reporter circuit 228, etc.). It should be appreciated that, in such embodiments, one or more of the instruction transmitter module 202, the data receiver module 210, the analysis module 214, and the reporter module 228 may form a portion of one or more of the processor 140, the I/O subsystem 142, and/or other components of the host computing device 102. Additionally, in some embodiments, one or more of the illustrative modules may form a portion of another module and/or one or more of the illustrative modules may be independent of one another. Further, in some embodiments, one or more of the modules of the environment 200 may be embodied as virtualized hardware components or emulated architecture, which may be established and maintained by the processor 140 or other components of the host computing device 102.

The instruction transmitter module 202, which may be embodied as hardware, firmware, software, virtualized hardware, emulated architecture, and/or a combination thereof as discussed above, is configured to transmit validation instructions 204 to the gateway device 104 to perform at least one function with respect to one or more of the field devices 105 communicatively coupled to the gateway device 104. Additionally, the instruction transmitter module 202 is configured to transmit forward instructions 206 to the gateway device 104. The forward instructions 206 instruct the gateway device 104 to transmit or forward the test data to the server computing device 126 for storage and/or analysis. In some embodiments, the instruction transmitter module 202 is also configured to transmit debug instructions 208 to the gateway device 104 to perform a debug process, for example when host computing device 102 detects an anomaly in the test data from the gateway device 104.

The data receiver module 210, which may be embodied as hardware, firmware, software, virtualized hardware, emulated architecture, and/or a combination thereof as discussed above, is configured to receive test data 212 from the gateway device 104. As described above, in some embodiments, the host computing device 102 may not include an instruction transmitter module 202 that transmits validation instructions 204, forward instructions 206, and/or debug instructions 208 to gateway device 104. Rather, in such embodiments, gateway device 104 is already configured to perform the functions in the validation instructions 204, forward instructions 206, and/or debug instructions 208 and the data receiver module 210 receives the test data 212 from the gateway device 104 without the host computing device 102 instructing the gateway device 104 to transmit the test data 212.

The analysis module 214, which may be embodied as hardware, firmware, software, virtualized hardware, emulated architecture, and/or a combination thereof as discussed above, is configured to manage and analyze validation of the field devices 105 and/or the gateway device 104. To do so, the analysis module 214 includes a functional test module 216, a regression test module 220, and a profile module 224. The functional test module 216 includes a functional test database 218 and is configured to determine whether the gateway device 104 is performing a basic level of functions with each field device 105. For example, the functional test module 216 determines whether the gateway device 104 is successfully receiving (“subscribing”) data, from each sensor device 106. Further, the functional test module 216 determines whether the gateway device 104 is successfully transmitting (“publishing”) data to each actuator device 108. The illustrative functional test module 216 determines whether the gateway device 104 is performing the above functions with each field device 105 in a sequential or one-by-one manner, rather than determining whether and how successfully the gateway device 104 is capable of communicating with multiple field devices 105 concurrently. Additionally, the functional test module 216 may be configured identify any anomalies 702 in the test data 212 and, in response to identifying one or more anomalies 702, performing a debug process. In some embodiments, the functional test module 216 transmits a signal to the instruction transmitter module 202 to transmit debug instructions 208 to the gateway device 104 to perform one or more debugging operations to facilitate identifying a source of the one or more anomalies 702. In other embodiments, the functional test module 216 may analyze the test data 212 to determine the source of the one or more anomalies 702 without the gateway device 104 performing debugging operations.

The regression test module 220 is configured to determine the ability of the gateway device 104 to communicate with multiple field devices 105 concurrently, over a predefined time period. The regression test module 220 includes a regression test database 222 that is described in more detail herein. The regression test module 220 tracks data 800 transmitted between the gateway device 104 and the field devices 105 over the predefined time period 806, for example seven days. For example, in at least some embodiments, the gateway device 104 transmits the data 800 communicated between the gateway device 104 and the field devices 105 in the test data 212 received by the data receiver module 210 described above. The regression test module 220 may also track processor utilization 802 and memory utilization 804 of the gateway device 104 over the predefined time period 806 (see FIG. 8). In some embodiments, the regression test module 220 is configured to identify one or more anomalies 702 in the test data 212 and, in response to identifying the one or more anomalies 702, performing a debug process. In some embodiments, the regression test module 220 may be configured to transmit a signal to the instruction transmitter module 202 to transmit debug instructions 208 to the gateway device 104 to perform one or more debugging operations to determine a source of the one or more anomalies 702 from the regression test. In other embodiments, the regression test module 220 may analyze the test data 212 and determines the source of the one or more anomalies 702 without the gateway device 104 performing any debugging operations.

The profile module 224 includes a profile database 226 and is configured to generate a profile 900 that measures the performance of the gateway device 104 and the field devices 105. To do so, in the illustrative embodiment, the profile module 224 characterizes at least one sensor data packet 700 included in the test data 212. More specifically, the profile module 224 may determine a number of data packets that were dropped during communications between the gateway device 104 and the field devices 105 during the predefined time period 806 or an average rate of data packet loss. In some embodiments, one or more of the sensor data packets 700 includes an indicator that the sensor data packet 700 was retransmitted, for example because the previous sensor data packet 700 was dropped. The profile module 224 executes an algorithm 902 that converts sensor data packets 700, received from the gateway device 104 for example in the test data 212 from a one format 904 to another format 906. For example, the sensor data packets 700 may include “raw” data from temperature sensor device 112 that defines voltage levels. The profile module 224 executes the algorithm 902 to convert the voltage levels (i.e., the format 904) to temperature values (i.e., the format 906). In other embodiments, the gateway device 104 performs the algorithm 902 and the profile module 224 measures the amount of time required by the gateway device 104 to perform the algorithm 902.

It should be appreciated that each of the functional test module 216, the regression test module 220, and the profile module 224 of the analysis module 214 may be separately embodied as hardware, firmware, software, virtualized hardware, emulated architecture, and/or a combination thereof. For example, the functional test module 216 may be embodied as a hardware component, while the regression test module 220 and/or the profile module 224 are embodied as a virtualized hardware component or as some other combination of hardware, firmware, software, virtualized hardware, emulated architecture, and/or a combination thereof.

The reporter module 228, which may be embodied as hardware, firmware, software, virtualized hardware, emulated architecture, and/or a combination thereof as discussed above, is configured to a generate a report 230 that indicates a status of the system 100 (e.g., a status of the gateway device 104 and/or one or more field devices 105, based on the functional test, the regression test, and the profile 900). For example, the report 230 may include results of components of the functional test, for example whether the gateway device 104 successfully received data from one or more field devices 105 and whether the gateway device 104 successfully transmitted data to one or more field devices 105. Additionally, in at least some embodiments, the report 230 includes results of components of the regression test, including for example, whether the gateway device 104 successfully communicated with a plurality of field devices 105 over the predefined time period 806, processor utilization 802 of the gateway device 104, and memory utilization 804 of the gateway device 104. Additionally, in some embodiments, the report includes a listing of anomalies 702 detected in the test data 212 and results of debugging processes. Further, in some embodiments, the report 230 includes information from the profile 900 generated by the profile module 224, for example an indication of the reliability of data transmissions between the gateway device 104 and the field devices 105, such as information pertaining to any data packet loss. Further, in some embodiments, the report 230 includes an indication of the time required to perform the algorithm 902 for converting raw sensor data from the format 904 to the format 906, and the results of the conversion.

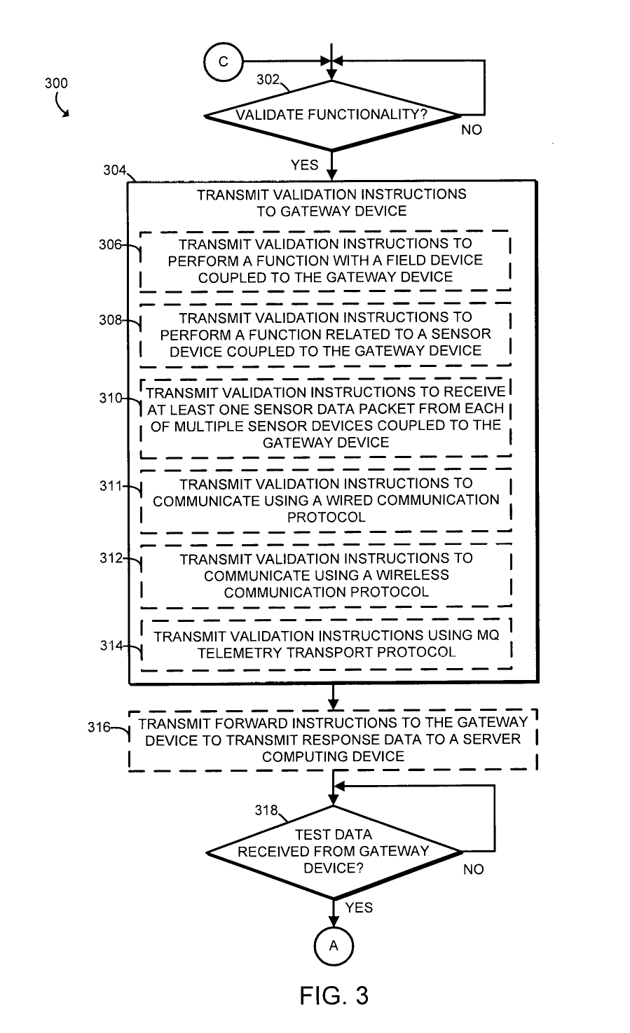

Referring now to FIG. 3, in use, the host computing device 102 may execute a method 300 for validating functionality of the gateway device 104 and the field devices 105. The method 300 begins with block 302, in which the host computing device 102 determines whether to proceed with validating functionality of the gateway device 104 and the field devices 105. If so, the method 300 proceeds to block 304, in which the host computing device 102 transmits the validation instructions 204 to the gateway device 104. For example, as shown in block 306, the host computing device 102 may transmit instructions to perform a function with a device, for example a field device 105, coupled to the gateway device 104. Additionally or alternatively, as shown in block 308, the host computing device 102 may transmit instructions for the gateway device 104 to perform a function related to a sensor device 106. Additionally or alternatively, as shown in block 310, the host computing device 102 may transmit instructions to receive at least one sensor data packet 700 from each of multiple sensor devices 106. Additionally or alternatively, as shown in block 311, the host computing device 102 may transmit instructions for the gateway device 104 to communicate with the field devices 105 using a wired communication protocol. Additionally or alternatively, as shown in block 312, the host computing device 102 may transmit instructions to communicate with the field devices 105 using a wireless communication protocol, for example a ZigBee or a Bluetooth protocol. Additionally or alternatively, as shown in block 314, the host computing device 102 may transmit the validation instructions 204 to the gateway device 104 using an MQ telemetry transport (“MQTT”) protocol.

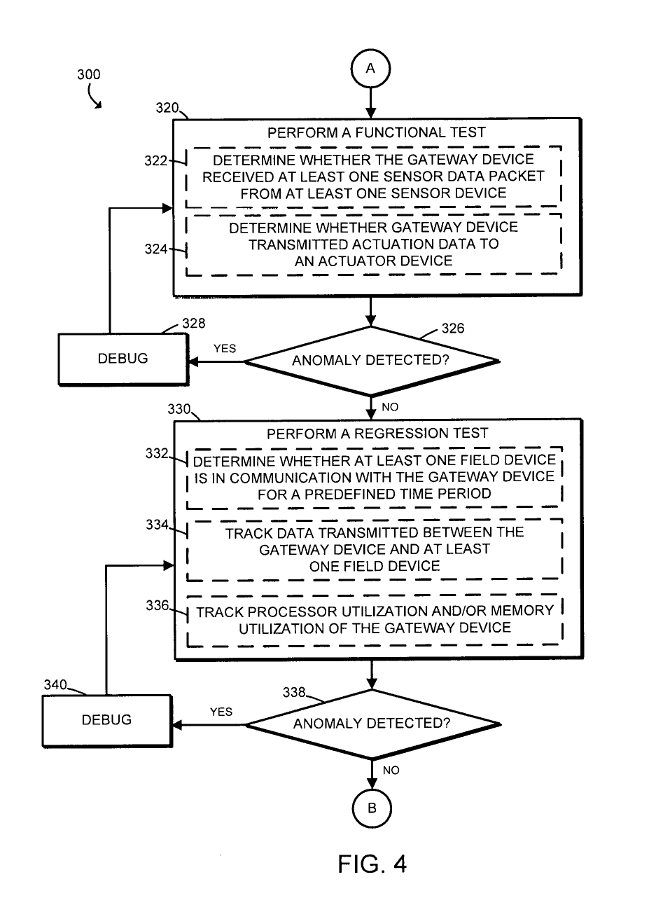

In some embodiments, in block 316, the host computing device 102 may transmit forward instructions 206 to the gateway device 104. The forward instructions 206 instruct the gateway device 104 to transmit (i.e., forward) the test data 212 to the server computing device 126 to store and/or analyze. In some embodiments, the gateway device 104 may already be programmed or otherwise configured to transmit the test data 212 to the host computing device 102 and, in some embodiments, also to the server computing device 126, without requiring the host computing device 102 to transmit specific instructions (e.g., the validation instructions 204 and/or the forward instructions 206) to the gateway device 104 to perform those functions. Further, as described above, the server computing device 126 and the host computing device 102 are the same computing device in some embodiments. Subsequently, in block 318, the host computing device 102 awaits to receive test data 212 from the gateway device 104. After the host computing device 102 receives the test data 212, the method 300 proceeds to block 320 of FIG. 4

In block 320, the host computing device 102 is configured to perform a functional test based on the validation instructions. For example, in block 322, the host computing device 102 may determine whether the gateway device 104 received at least one sensor data packet 700 from at least one sensor device 106. As described above, the test data 212 includes sensor data packets 700. Accordingly, the lack of sensor data packets 700 in the test data 212 indicates that the gateway device 104 did not receive at least one sensor data packet 700 during the functional test. In some embodiments, rather than determining that the gateway device 104 did not receive sensor data packets 700 based on an absence of sensor data packets 700 in the test data 212, the host computing device 102 may detect a flag in the test data 212 indicating that the gateway device 104 did or did not receive at least one sensor data packet 700. Additionally or alternatively, in block 324, the host computing device 102 may determine whether the gateway device 104 transmitted actuation data 800 to at least one actuator device 108. For example, the host computing device 102 may detect an acknowledgement from an actuator device 108 in data 800 transmitted between the gateway device 104 and the field devices 105.

After the host computing device 102 completes the functional test in block 320, the method 300 advances to block 326 in which the host computing device 102 determines whether an anomaly has been detected in response to the functional test. For example, if any portion the functional test 320, for example the receipt of data packets from a sensor device 106 or the transmission of actuation data 800 to an actuator device 108, failed (i.e., produced an anomaly 702) in the test data 212, the host computing device 102 may determine that the functional test indicates an anomaly. If so, the method 300 advances to block 328 in which the host computing device 102 performs a debug process. For example, in some embodiments, the host computing device 102 may transmit a signal to the instruction transmitter module 202 to transmit debug instructions 208 to the gateway device 104 to identify a source of the anomaly. In other embodiments, the host computing device 102 may analyze the test data 212 to determine the source of the anomaly 702.

Referring back to block 326, if the host computing device 102 does not detect any anomalies in the test data 212, the method 300 advances to block 330. In block 330, the host computing device 102 performs a regression test based on the validation instructions. To do so, in block 332, the host computing device 102 may determine whether at least one field device 105, for example a sensor device 106, is in communication with the gateway device 104 for a predefined time period (e.g., predefined time period 806). In some embodiments, in block 334 334, the host computing device 102 may determine whether the gateway device 104 is successfully recording and reporting data 800, for example actuation data or sensor data, that was communicated between the gateway device 104 and at least one field device 105 (e.g., at least one sensor device 106), thereby enabling the host computing device 102 to track the communicated data 800. Additionally, in some embodiments in block 336, the host computing device 102 may determine whether the gateway device 104 is transmitting processor utilization data and memory utilization data to the host computing device 102, thereby enabling the host computing device 102 to track the processor utilization 802 and the memory utilization 804 of the gateway device 104. After the debug process is completed, the method 300 loops back to block 320 in which the host computing device 102 repeats the function test.

After the host computing device 102 completes the regression test in block 330, the method 300 advances to block 338 in which the host computing device 102 determines whether an anomaly has been detected in response to the regression test. For example, if any portion of the regression test 330 failed (i.e., produced an anomaly 702) in the test data 212, the host computing device 102 may determine that the regression test indicates an anomaly. If so, the method 300 advances to block 340 in which the host computing device 102 performs a debug process. In some embodiments, the host computing device 102 may transmit debug instructions 208 to the gateway device 104 to identify a source of the anomaly. In other embodiments, the host computing device 102 may analyze the test data 212 to determine the source of the anomaly 702. After the debug process is completed, the method 300 loops back to block 330 in which the host computing device 102 repeats the regression test.

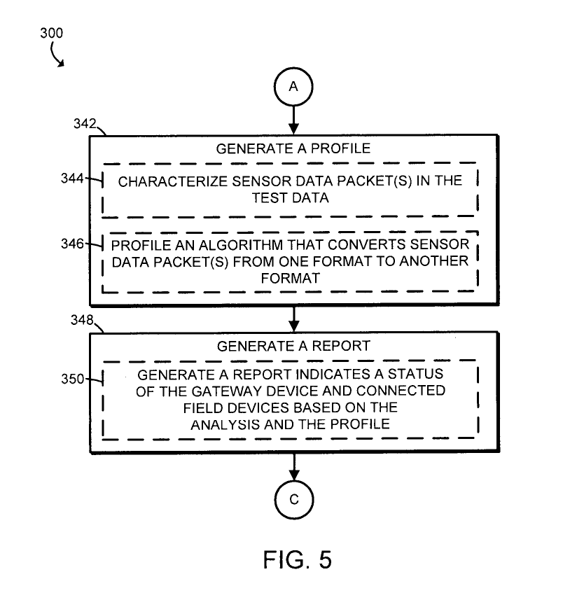

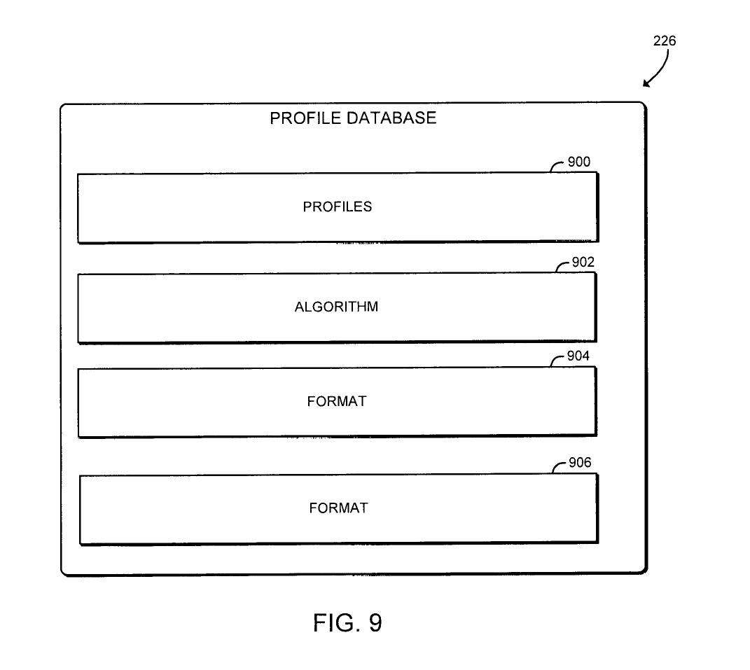

Referring back to block 326, if the host computing device 102 docs not detect any anomalies in response to the regression test of block 330, the method 300 advances to block 342 of FIG. 5. In block 342, the host computing device 102 generates a profile 900 (see FIG. 9) based at least in part on the test data 212. To do so, in block 344, the host computing device 102 may characterize the sensor data packets 700 in the test data 212. For example, the host computing device 102 may determine a reliability with which the gateway device 104 communicates with the field device 105. More specifically, in at least some embodiments, the host computing device 102 may determine a number of data packets (e.g., data packets 700) that were dropped during a predefined time period (e.g., predefined time period 806). As shown at block 346, the host computing device 102 may profile an algorithm (e.g., algorithm 902) that converts raw sensor data (e.g., data packets 700) from one format 904 to another format 906. More specifically, in the illustrative embodiment, the host computing device 102 measures an amount of time that elapses for the algorithm 902 to be performed. In some embodiments, the algorithm 902 is executed by the host computing device 102. In other embodiments, the algorithm 902 is executed by the gateway device 104.

Subsequently, in block 348, the host computing device 102 generates a report 230. For example, in block 350, the host computing device 102 may generate a report 230 that indicates the status of the system 100, for example the gateway device 104 and one or more of field devices 105, based on the analysis and the profile generated in the method 300. The host computing device 102 may cause the report 230 to be displayed, for example on the display 150. Additionally or alternatively, the host computing device 102 may transmit the report 230 to another computing device, such as server computing device 126.

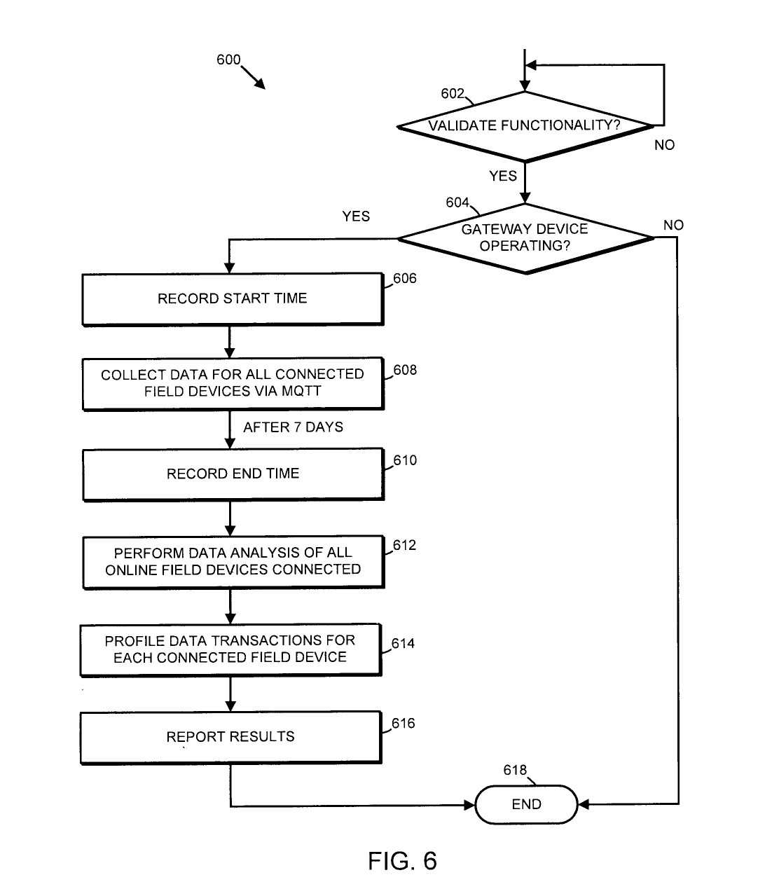

Referring now to FIG. 6, in use, the host computing device 102 may execute another method 600 for validating functionality of the gateway device 104 and the field devices 105. The method 600 begins with block 602 in which the host computing device 102 determines whether to proceed with validating functionality of the gateway device 104 and the field devices 105. If the host computing device 102 determines to proceed with the validation, the method 600 advances to block 604 in which the host computing device 102 determines whether the gateway device 104 is operating. For example, the processes performed in block 604 may represent a functional test of the system 100. If the host computing device 102 determines that the gateway device 104 is not operating in block 604 (e.g., the gateway device 104 is not transmitting data to the host computing device 102), the method 600 advances to block 618 in which the method 600 terminates.

If, however, the host computing device 102 determines that the gateway device 104 is operating, the method proceeds to block 606, which represents the beginning of an illustrative regression test. In block 606, the host computing device 102 records a start time. The start time is defined as the beginning of the predefined time period 806 for the regression test. Subsequently, in block 608, the host computing device 102 collects data for all field devices 105 (e.g., sensor devices 106 and/or actuator devices 108) that are connected to the gateway device 104. To do so, the host computing device 102 may collect the data by communicating with the gateway device 104 using a communication protocol, for example MQTT. After the predefined time period 806 (e.g., 7 days as shown in FIG. 6), the method 600 proceeds to block 610 in which the host computing device 102 records the end time of the predefined time period 806. Subsequently, in block 612, the host computing device 102 performs an analysis of data (e.g., data packets 700) collected from all of the online field devices 105 connected to the gateway device 104. In block 614, the host computing device 102 profiles (e.g., generates profile 900) the data transactions for each field device 105. For example, as described above, the host computing device 102 may generate a report that indicates an average rate that data packets were dropped and/or a total amount of data packets that were dropped during the predefined time period 806 for the regression test. Subsequently, in block 616, the host computing device 102 reports the results of the tests (e.g., block 604 through block 614). The host computing device 102 may report the results by generating a report 230, as described above. After the host computing device 102 generates the results report, the method 600 advances to block 616 in which method 600 terminates.

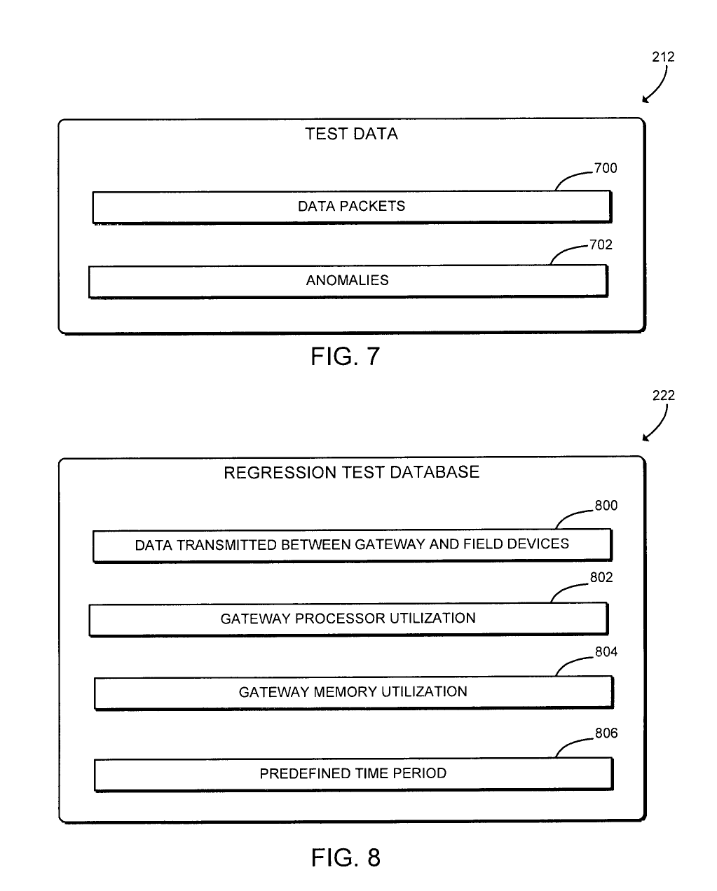

Referring now to FIG. 7, a simplified block diagram of components of the test data 212 that may be analyzed by the host computing device 102, is shown. The illustrative test data 212 includes data packets 700, for example packets of data received from the field devices 105, including one or more sensor devices 106 and/or one or more actuator devices 108. Additionally, the illustrative test data 212 includes anomalies 702. The anomalies 702 indicate that one or more devices in system 100, for example gateway device 104 and/or one or more of field devices 105 is not operating at all, or not operating within parameters associated with the functional test or the regression test described above. It should be understood that in some embodiments, the test data 212 does not include any anomalies 702.

Referring now to FIG. 8, a simplified block diagram of components of the regression test database 222 is shown. As described above, the host computing device 102, accesses (i.e., stores data in and/or retrieves data from) the regression test database 222. The regression test database 222 includes data 800 transmitted between the gateway device 104 and the field devices 105. Additionally, the regression test database 222 includes processor utilization data 802 of the gateway device 104 and memory utilization data 804 of the gateway device 104. As should be understood from the above description of the processes performed by the host computing device 102, the host computing device 102 extracts or extrapolates the above-described components of the regression test database 222 from the test data 212 transmitted from the gateway device 104. Additionally, the regression test database 222 includes a predefined time period 806 that specifies how long the host computing device 102 collects data from the gateway device 104 for the regression test.

Referring now to FIG. 9, a simplified block diagram of components of the profile database 226 that is accessed by the host computing device 102 is shown. The profile database 226 includes one or more profiles 900 generated by the host computing device 102. Additionally, in at least some embodiments, the profile database 226 includes the algorithm 902 that is executed by the host computing device 102 or the gateway device 104 to convert raw data (e.g., data packets 700) from one or more field devices 105 from one format 904 (e.g., voltage levels) to another format 906 (e.g., temperature values). In the illustrative embodiment, the profile database 226 may include rules defining the two different formats 904 and 906.

### EXAMPLES

Illustrative examples of the technologies disclosed herein are provided below. An embodiment of the technologies may include any one or more, and any combination of, the examples described below.

Example 1 includes a host computing device for validating functionality of a system that includes a gateway device communicatively coupled to at least one sensor device, the host computing device comprising an instruction transmitter module to transmit validation instructions to the gateway device to perform at least one function with respect to the at least one sensor device that is communicatively coupled to the gateway device; a data receiver module to receive test data from the gateway device; an analysis module to perform an analysis of the test data to determine whether the system passed at least one of a functional test and a regression test, and generate a profile of the test data based on at least one sensor data packet included in the test data; and a reporter module to generate a report that indicates a status of the system, based on the analysis and the profile.

Example 2 includes the subject matter of Example 1, and wherein the analysis module further comprises a functional test module to determine whether the gateway device received the at least one sensor data packet from the at least one sensor device.

Example 3 includes the subject matter of any of Examples 1 and 2, and wherein the system further includes an actuator device that is communicatively coupled to the gateway device and the analysis module further comprises a functional test module to determine whether the gateway device transmitted actuation data to the actuator device.

Example 4 includes the subject matter of any of Examples 1-3, and wherein the analysis module further comprises a regression test module to determine whether the at least one sensor device is in communication with the gateway device for at least a predefined time period.

Example 5 includes the subject matter of any of Examples 1-4, and wherein the analysis module further comprises a regression test module to track data transmitted between the gateway device and the at least one sensor device.

Example 6 includes the subject matter of any of Examples 1-5, and wherein the analysis module further comprises a regression test module to track at least one of a processor utilization and a memory utilization of the gateway device.

Example 7 includes the subject matter of any of Examples 1-6, and wherein the analysis module further comprises a profile module that profiles an algorithm that converts the at least one sensor data packet from a first format to a second format.

Example 8 includes the subject matter of any of Examples 1-7, and wherein the instruction transmitter module is further to transmit forward instructions to the gateway device to transmit the test data to at least one server computing device for analytics.

Example 9 includes the subject matter of any of Examples 1-8, and wherein the at least one sensor device includes a plurality of sensor devices, and the instruction transmitter module is further to transmit the validation instructions to the gateway device to receive the at least one sensor data packet from each of the plurality of sensor devices.

Example 10 includes the subject matter of any of Examples 1-9, and wherein the instruction transmitter module is further to transmit the validation instructions with an MQ telemetry transport protocol.

Example 11 includes the subject matter of any of Examples 1-10, and wherein the analysis module is further to detect an anomaly in the test data; and the instruction transmitter module is further to transmit debug instructions to the gateway device to perform a debug process, in response to the detection of the anomaly.

Example 12 includes the subject matter of any of Examples 1-11, and wherein the instruction transmitter module is further to transmit validation instructions to the gateway device to communicate with the at least one sensor device wirelessly.

Example 13 includes the subject matter of any of Examples 1-12, and wherein the instruction transmitter module is further to transmit validation instructions to the gateway device to use a wired communication protocol to communicate with the at least one sensor device.

Example 14 includes the subject matter of any of Examples 1-13, and further including a profile module to measure an amount of time required by the gateway device to convert a first plurality of data points received from the at least one sensor device to a second plurality of data points, wherein the first plurality of data points correspond to a first metric and the second plurality of data points correspond to a second metric that is different from the first metric.

Example 15 includes the subject matter of any of Examples 1-14, and wherein the profile module is further to determine a number of data packets that were dropped during communications between the gateway device and the at least one sensor device during a predefined time period.

Example 16 includes the subject matter of any of Examples 1-15, and wherein the profile module is further to determine an average data transfer rate between the gateway device and the at least one sensor device during a predefined time period.

Example 17 includes a method for validating functionality of a system that includes a gateway device communicatively coupled to at least one sensor device, the method comprising transmitting, by a host computing device, validation instructions to the gateway device to perform at least one function with respect to the at least one sensor device that is communicatively coupled to the gateway device; receiving, by the host computing device, test data from the gateway device after transmitting the validation instructions; analyzing, by the host computing device, the test data to determine whether the system passed at least one of a functional test and a regression test; profiling, by the host computing device, the test data at least by characterizing at least one sensor data packet included in the test data; and generating, by the host computing device, a report that indicates a status of the system, based on the analyzing and the profiling.

Example 18 includes the subject matter of Example 17, and further including determining, by the host computing device, that the gateway device received the at least one sensor data packet from the at least one sensor device.

Example 19 includes the subject matter of any of Examples 17 and 18, and wherein the system further includes an actuator device that is communicatively coupled to the gateway device, the method further comprising determining, by the host computing device, that the gateway device transmitted actuation data to the actuator device.

Example 20 includes the subject matter of any of Examples 17-19, and further including determining, by the host computing device, that the at least one sensor device is in communication with the gateway device for at least a predefined time period.

Example 21 includes the subject matter of any of Examples 17-20, and further including determining, by the host computing device, that the host computing device is tracking data transmitted between the gateway device and the at least one sensor device.

Example 22 includes the subject matter of any of Examples 17-21, and further including determining, by the host computing device, that the host computing device is tracking at least one of a processor utilization and a memory utilization of the gateway device.

Example 23 includes the subject matter of any of Examples 17-22, and further including profiling, by the host computing device, an algorithm that converts the at least one sensor data packet from a first format to a second format.

Example 24 includes the subject matter of any of Examples 17-23, and further including transmitting, by the host computing device, forward instructions to the gateway device to transmit the test data to at least one server computing device for analytics.

Example 25 includes the subject matter of any of Examples 17-24, and wherein the at least one sensor device includes a plurality of sensor devices, and transmitting validation instructions to perform at least one function further comprises transmitting validation instructions to the gateway device to receive the at least one sensor data packet from each of the plurality of sensor devices.

Example 26 includes the subject matter of any of Examples 17-25, and wherein transmitting the validation instructions further comprises transmitting the validation instructions using an MQ telemetry transport protocol.

Example 27 includes the subject matter of any of Examples 17-26, and wherein transmitting the instructions further comprises transmitting the validation instructions to the gateway device to communicate with the at least one sensor device using a wireless communication protocol.

Example 28 includes the subject matter of any of Examples 17-27, and wherein transmitting the validation instructions further comprises transmitting the validation instructions to the gateway device to communicate with the at least one sensor device using a wired communication protocol.

Example 29 includes the subject matter of any of Examples 17-28, and further including detecting, by the host computing device, an anomaly in the test data; and transmitting, by the host computing device, debug instructions to the gateway device to perform a debug process, in response to the detection of the anomaly.

Example 30 includes the subject matter of any of Examples 17-29, and further including measuring, by the host computing device, an amount of time required by the gateway device to convert a first plurality of data points received from the at least one sensor device to a second plurality of data points, wherein the first plurality of data points correspond to a first metric and the second plurality of data points correspond to a second metric that is different from the first metric.

Example 31 includes the subject matter of any of Examples 17-30, and further including determining, by the host computing device, a number of data packets that were dropped during communications between the gateway device and the at least one sensor device during a predefined time period.

Example 32 includes the subject matter of any of Examples 17-31, and further including determining, by the host computing device, an average data transfer rate between the gateway device and the at least one sensor device during a predefined time period.

Example 33 includes one or more computer-readable storage media comprising a plurality of instructions that, when executed, cause a host computing device to perform the method of any of Examples 17-32.

Example 34 includes a host computing device for validating functionality of a system that includes a gateway device communicatively coupled to at least one sensor device, the host computing device comprising means for transmitting validation instructions to the gateway device to perform at least one function with respect to the at least one sensor device that is communicatively coupled to the gateway device; means for receiving test data from the gateway device after transmitting the validation instructions; means for analyzing the test data to determine whether the system passed at least one of a functional test and a regression test; means for profiling the test data at least by characterizing at least one sensor data packet included in the test data; and means for generating a report that indicates a status of the system, based on the analyzing and the profiling.

Example 35 includes the subject matter of Example 34, and further including means for determining that the gateway device received the at least one sensor data packet from the at least one sensor device.

Example 36 includes the subject matter of any of Examples 34 and 35, and wherein the system further includes an actuator device that is communicatively coupled to the gateway device, the host computing device further comprising means for determining that the gateway device transmitted actuation data to the actuator device.

Example 37 includes the subject matter of any of Examples 34-36, and further including means for determining that the at least one sensor device is in communication with the gateway device for at least a predefined time period.

Example 38 includes the subject matter of any of Examples 34-37, and further including means for determining that the host computing device is tracking data transmitted between the gateway device and the at least one sensor device.

Example 39 includes the subject matter of any of Examples 34-38, and further including means for determining that the host computing device is tracking at least one of a processor utilization and a memory utilization of the gateway device.

Example 40 includes the subject matter of any of Examples 34-39, and further including means for profiling an algorithm that converts the at least one sensor data packet from a first format to a second format.

Example 41 includes the subject matter of any of Examples 34-40, and further including means for transmitting forward instructions to the gateway device to transmit the test data to at least one server computing device for analytics.

Example 42 includes the subject matter of any of Examples 34-41, and wherein the at least one sensor device includes a plurality of sensor devices, and the means for transmitting validation instructions to perform at least one function comprises means for transmitting validation instructions to the gateway device to receive the at least one sensor data packet from each of the plurality of sensor devices.

Example 43 includes the subject matter of any of Examples 34-42, and wherein the means for transmitting the validation instructions comprises means for transmitting the validation instructions using an MQ telemetry transport protocol.

Example 44 includes the subject matter of any of Examples 34-43, and wherein the means for transmitting the instructions comprises means for transmitting the validation instructions to the gateway device to communicate with the at least one sensor device using a wireless communication protocol.

Example 45 includes the subject matter of any of Examples 34-44, and wherein the means for transmitting the validation instructions comprises means for transmitting the validation instructions to the gateway device to communicate with the at least one sensor device using a wired communication protocol.

Example 46 includes the subject matter of any of Examples 34-45, and further including means for detecting an anomaly in the test data; and means for transmitting debug instructions to the gateway device to perform a debug process, in response to the detection of the anomaly.

Example 47 includes the subject matter of any of Examples 34-46, and further including means for measuring an amount of time required by the gateway device to convert a first plurality of data points received from the at least one sensor device to a second plurality of data points, wherein the first plurality of data points correspond to a first metric and the second plurality of data points correspond to a second metric that is different from the first metric.

Example 48 includes the subject matter of any of Examples 34-47, and further including means for determining a number of data packets that were dropped during communications between the gateway device and the at least one sensor device during a predefined time period.

Example 49 includes the subject matter of any of Examples 34-48, and further including means for determining an average data transfer rate between the gateway device and the at least one sensor device during a predefined time period.

1. A host computing device for validating functionality of a system that includes a gateway device communicatively coupled to at least one sensor device, the host computing device comprising:
an instruction transmitter module to transmit validation instructions to the gateway device to perform at least one function with respect to the at least one sensor device that is communicatively coupled to the gateway device;
a data receiver module to receive test data from the gateway device;
an analysis module to perform an analysis of the test data to determine whether the system passed at least one of a functional test and a regression test, and generate a profile of the test data based on at least one sensor data packet included in the test data; and
a reporter module to generate a report that indicates a status of the system, based on the analysis and the profile.

2. The host computing device of claim 1, wherein the analysis module further comprises a functional test module to determine whether the gateway device received the at least one sensor data packet from the at least one sensor device.

3. The host computing device of claim 1, wherein the system further includes an actuator device that is communicatively coupled to the gateway device and the analysis module further comprises a functional test module to determine whether the gateway device transmitted actuation data to the actuator device.

4. The host computing device of claim 1, wherein the analysis module further comprises a regression test module to determine whether the at least one sensor device is in communication with the gateway device for at least a predefined time period.

5. The host computing device of claim 1, wherein the analysis module further comprises a regression test module to track data transmitted between the gateway device and the at least one sensor device.

6. The host computing device of claim 1, wherein the analysis module further comprises a regression test module to track at least one of a processor utilization and a memory utilization of the gateway device.

7. The host computing device of claim 1, wherein the analysis module further comprises a profile module that profiles an algorithm that converts the at least one sensor data packet from a first format to a second format.

8. The host computing device of claim 1, wherein the instruction transmitter module is further to transmit forward instructions to the gateway device to transmit the test data to at least one server computing device for analytics.

9. The host computing device of claim 1, wherein the at least one sensor device includes a plurality of sensor devices, and the instruction transmitter module is further to transmit the validation instructions to the gateway device to receive the at least one sensor data packet from each of the plurality of sensor devices.

10. One or more computer-readable storage media comprising a plurality of instructions stored thereon that, when executed, cause a host computing device to:
transmit validation instructions to a gateway device to perform at least one function with respect to at least one sensor device that is communicatively coupled to the gateway device;
receive test data from the gateway device after the validation instructions are transmitted;
analyze the test data to determine whether the system passed at least one of a functional test and a regression test;
profile the test data based on a characterization of at least one sensor data packet included in the test data; and
generate a report that indicates a status of the system, based on the analysis and the profile.

11. The one or more computer-readable storage media of claim 10, wherein the plurality of instructions, when executed, further cause the host computing device to determine that the gateway device received the at least one sensor data packet from the at least one sensor device.

12. The one or more computer-readable storage media of claim 10, wherein the system further includes an actuator device that is communicatively coupled to the gateway device and the plurality of instructions, when executed, further cause the host computing device to determine that the gateway device transmitted actuation data to the actuator device.

13. The one or more computer-readable storage media of claim 10, wherein the plurality of instructions, when executed, further cause the host computing device to determine that the at least one sensor device is in communication with the gateway device for at least a predefined time period.

14. The one or more computer-readable storage media of claim 10, wherein the plurality of instructions, when executed, further cause the host computing device to determine that the host computing device tracks data transmitted between the gateway device and the at least one sensor device.

15. The one or more computer-readable storage media of claim 10, wherein the plurality of instructions, when executed, further cause the host computing device to determine that the host computing device tracks at least one of a processor utilization and a memory utilization of the gateway device.

16. The one or more computer-readable storage media of claim 10, wherein the plurality of instructions, when executed, further cause the host computing device to transmit forward instructions to the gateway device to transmit the test data to at least one server computing device for analytics.

17. The one or more computer-readable storage media of claim 10, wherein the at least one sensor device includes a plurality of sensor devices, and to transmit validation instructions to perform at least one function comprises to transmit validation instructions to the gateway device to receive the at least one sensor data packet from each of the plurality of sensor devices.

18. A method for validating functionality of a system that includes a gateway device communicatively coupled to at least one sensor device, the method comprising:
transmitting, by a host computing device, validation instructions to the gateway device to perform at least one function with respect to the at least one sensor device that is communicatively coupled to the gateway device;
receiving, by the host computing device, test data from the gateway device after transmitting the validation instructions;
analyzing, by the host computing device, the test data to determine whether the system passed at least one of a functional test and a regression test;
profiling, by the host computing device, the test data at least by characterizing at least one sensor data packet included in the test data; and
generating, by the host computing device, a report that indicates a status of the system, based on the analyzing and the profiling.

19. The method of claim 18, further comprising determining, by the host computing device, that the gateway device received the at least one sensor data packet from the at least one sensor device.

20. The method of claim 18, wherein the system further includes an actuator device that is communicatively coupled to the gateway device, the method further comprising determining, by the host computing device, that the gateway device transmitted actuation data to the actuator device.

21. The method of claim 18, further comprising determining, by the host computing device, that the at least one sensor device is in communication with the gateway device for at least a predefined time period.

22. The method of claim 18, further comprising determining, by the host computing device, that the host computing device is tracking data transmitted between the gateway device and the at least one sensor device.

23. The method of claim 18, further comprising determining, by the host computing device, that the host computing device is tracking at least one of a processor utilization and a memory utilization of the gateway device.

24. The method of claim 18, further comprising transmitting, by the host computing device, forward instructions to the gateway device to transmit the test data to at least one server computing device for analytics.

25. The method of claim 18, wherein the at least one sensor device includes a plurality of sensor devices, and transmitting validation instructions to perform at least one function further comprises transmitting validation instructions to the gateway device to receive the at least one sensor data packet from each of the plurality of sensor devices.
